(19) United States
(12) Patent Application Publication
(10) Pub. No.: US 2024/0109227 A1
(43) Pub. Date: Apr. 4, 2024

(54) MANAGEMENT OF RECYCLABLE GOODS AND THEIR SOURCE MATERIALS

(71) Applicant: SECURITY MATTERS LTD., D.N. Revel Eilot (IL)

(72) Inventors: Haggai ALON, Kibbutz Naan (IL); Tehila NAHUM, Holon (IL); Nadav YORAN, Tel Aviv (IL)

(21) Appl. No.: 17/769,175

(22) PCT Filed: Oct. 15, 2020
(86) PCT No.: PCT/IL2020/051099

§ 371 Date: Apr. 14, 2022

Related U.S. Application Data
(60) Provisional application No. 62/915,132, filed on Oct. 15, 2019.

(51) Int. Cl. B29B 17/02; B29B 9/10

(52) U.S. Cl. CPC B29B 17/02; B29B 9/10; B29B 2017/0203; B29B 2017/0268; B29B 2017/0275

(57) ABSTRACT

Techniques for managing production and reuse of a recyclable material are disclosed. Combination of markers introduced into one or more ingredient material components of recyclable materials are used to indicate one or more properties of at least one of the ingredient material components e.g., a type of material used, percentage of the material type in the recyclable material, and suchlike. A signal obtained from a product comprising the recyclable material can be processed to detect presence or absence of the combination of markers therein. Based on the detection of the combination of markers, information indicative of the one or more properties of the at least one ingredient material component is determined, and based on the information it is decided either about a suitable recycling process for reusing the at least one ingredient material component, or a suitable disposal process for disposing the product.

### TECHNOLOGICAL FIELD

The present application is generally in the field of marking, tracing and managing recyclable goods, and in particular recyclable plastic goods.

### BACKGROUND

Plastic is one of the world's most-used materials. The problem with plastic lies not in how it is used but in the end-of-life management of products made from it. Only a small percentage of the plastic is recycled or incinerated, while most of the plastic ends up as waste in landfills, or worse, dumped in the wild and/or finds its way to the oceans. Due to this growing problem there is an urgent need for recycling and reuse of plastic products. A major problem in recycling plastic products is the fact the such products are usually comprised of various different polymeric materials (sometimes together with other types of additives), the exact composition/mix of which, and/or their relative part or concentration within the product, is usually unknown. This makes the sorting and recycling of the product almost infeasible, since the recycling processes (chemical or mechanical), in many cases, are designed according to the specific polymeric materials from which the recycled products are comprised.

Some recycling techniques known from the patent literature will be briefly described hereinbelow.

US Patent Publication No. 2015/050548 describes a process for the production of a recyclable product made from a first material, wherein before or during the production of the product a first marking material is added to the first material, and the product is produced from the first material with the admixed marking material, wherein the first marking material can be automatically detected in a recycling plant in the first material of the product after the production thereof. Also disclosed a process for the recycling of a product, wherein the product is manufactured from a first material, to which a first marking material is added, wherein the product, or pieces of the product, are separated from one another and/or from other objects in a recycling plant, in that the first marking material is detected in the first material of the product, or the pieces of the product, and the product, or the pieces of the product, are separated from one another and/or other objects, in which no marking material or a different, second marking material is detected.

U.S. Pat. No. 5,397,819 teaches a method for tagging thermoplastic containers using near infrared fluorescing compounds or copolymerized residues readily capable of detection. Also disclosed a method for identifying a thermoplastic container, thermoplastic polymer compositions comprised of the near infrared fluorescing compounds or residues and articles comprised of such compositions, new compounds useful as near infrared fluorophoric markers in the practice of the invention. The disclosed methods, compositions, and compounds, provide a total system useful for marking, for identification purposes, the various classes of thermoplastic wastes, so that they can be identified, sorted, and subsequently recycled.

GB Patent Publication No. 2330409 describes a system to identify a substance e.g., a type of plastic in a recycling system. A sample is illuminated with ultraviolet light and the induced fluorescence is detected. An image relating to the intensity of the detected fluorescence is stored and compared to reference data to allow the substance to be identified. The plastic may be impregnated with a plurality of fluorescent tracers to produce a characteristic fluorescence for that plastic type.

US Patent Publication No. 2014/0199508 teaches a method for reclaiming bio-based plastic material, including providing a bio-based plastic article, the article including an identifier, determining article content information from or via the identifier, and recycling the article based on article content information. Further disclosed a system for reclaiming bio-based plastic material, including an apparatus or device configured to obtain or determine a bio-based material content associated with a plastic article, and an apparatus or device configured to sort the plastic article based upon the bio-based material content of the plastic article. A bio-based plastic article comprising recycled bio-based material is also disclosed.

German Patent Publication No. DE3934969 suggests marking products made of raw materials of specific chemical compositions, in the production and reutilisation of various mass-produced plastic products. The products are marked to show their chemical composition during, or after, manufacture. After they have been used once or more, the products are identified and sorted according to their chemical composition, and reprocessed immediately or after storage. Coloured additives may be used with manual or automatic identification and sorting, recesses, holes and/or projections, with identification using mechanical scanners, or optical readers, and/or (multi)coloured marks or strips, bar codes, at predetermined point(s) on the surface of the products. Automatic identification can be performed with an optical reader.

F. Bezati et al, (“Addition of X-ray fluorescent tracers into polymers, new technology for automatic sorting of plastics: Proposal for selecting some relevant tracers”, Resour. Conserv. Recycl., 55 (12) (2011), pp. 1214-1221) suggest automatic sorting of plastics, based on X-ray fluorescence detection of tracers, added in such materials. The study describes the criteria for the selection of tracers, and concluded that the most adapted for XRF are some rare earth oxides. The plastics chosen for tracing and identification are the ones contained in ELV and WEEE from which discrimination is difficult for the existing sorting techniques due to their black colour.

General Description

The present disclosure relates to system, techniques and methods for managing the use of recyclable materials and products throughout their life cycle, from the production of raw materials, through the production of intermediate materials, the processing thereof for production and use of finished goods and products, and up to the waste segregation, recycling and reuse of these materials and products. The technique disclosed herein allows tracking, managing, sorting, and optionally also tokenizing and/or quality supervising/monitoring, the reuse of recyclable materials comprised in a similar, or a different, final product, throughout its life-cycle, and moreover, managing the reuse of such recyclable materials through several life-cycle periods.

According to a broad aspect of the present disclosure recyclable ingredient and/or raw materials of a final product are marked during production with one or more detectable taggant substances for allowing decomposing them therefrom, and reuse of the decomposed materials. In a non-limiting example, the marked recyclable material(s) may be a raw material, such as crude oil, petrochemical industry products, polymeric materials (e.g., as resins and pellets), used in the plastic industry. The ingredient/raw recyclable materials can be marked by marker/taggant elements that are applied (e.g., printed, coated, sprayed) onto, or inserted/mixed into, the ingredient/raw recyclable materials. The taggants/marker materials may be configured to emit an electromagnetic signal, that may be detected by a suitable spectrometer (reader, e.g., such as described in international patent publication WO 2019/175878, of the same applicant hereof, the disclosure of which is incorporated herein by reference).

In a non-limiting example, the taggant/marker materials are configured to emit a signal in response to an incoming electromagnetic radiation, for example, but not limited to, such as used with ultraviolet (UV), X-ray diffraction (XRD), or X-ray Fluorescence (XRF), markers. XRF markers may be detected and measured by X-Ray Fluorescence analysis utilizing XRF spectrometers (readers), which may detect and identify their response (signature) signals. In a non-limiting example, the XRF readers are implemented utilizing energy dispersive X-Ray fluorescence (EDXRF) spectrometer(s).

XRF markers are flexible, namely, they may be combined, blended, or form compounds with, or embedded within, a huge range of carriers, materials, and substrates, without negatively affecting their signature signals. The XRF markers may be, for example, in the form of inorganic salts, metal oxides, Bi or Tri metal atom molecules, polyatomic ions, and organometallic molecules (as described for instance in U.S. Provisional Patent Application No. 62/874,141, of the same applicant hereof, the disclosure of which is incorporated herein by reference.)

In a non-limiting example, XRF markers may be blended or applied to inorganic material(s) (e.g., metals), or organic (e.g., polymeric) materials, as described in international patent publication No. WO 2018/069917, the disclosure of which is incorporated herein by reference. Due to this flexibility, XRF markers, or a marking composition including several XRF markers (possibly with additional materials, such as carriers or additives), may be designed to have a preselected set of properties.

For example, and without limiting, XRF marker(s), or a marking composition, may be designed to be durable, such that it cannot be removed from the recyclable material, or final product, in which it is embedded (at least not without harming the recyclable material or destroying the final product). Durable XRF markers are robust and tamper-proof such that they cannot be altered. Alternatively, the XRF markers may be designed to be non-durable such that they can be easily decomposed, or removed from recyclable materials or substrates carrying them.

In yet another non-limiting example, the XRF marker(s), or marking composition, may be designed to be semi-durable, such that they may be partially decomposed, separated, or removed from the recyclable material in which they are embedded by specific chemical and/or mechanical process. For instance, by undergoing preselected process in preselected conditions, the concentration of the semi-durable marker/taggant materials within the recyclable material in which they are embedded will decrease.

In addition, XRF marking can be detected and identified also when markers are present under the external surface of an object, and not necessarily on its external surface, for instance, when the object is covered by a packaging material, dirt or dust. Furthermore, XRF analysis enables the measurement of the concentration of the marker/taggant materials present within the recyclable material, as well as the ratio (the relative concentration) of each one of the marker/taggant materials within the recyclable material.

The present disclosure provides a novel approach for overcoming problems relating to recycling of plastic products, and in particular products including various different recyclable polymeric materials (multi-material products).

To this end, marker/taggant materials are introduced, applied, or inserted, to one or more of the recyclable polymeric materials, from which the final product is comprised. The final product may be made entirely of plastic, or may include non-polymeric materials which may be removed from the final product at the recycling stage. A marking composition including one or more marker/taggant materials may be added to a recyclable polymeric material during its production e.g., the marker/taggant materials may be mixed/combined with raw materials of the recyclable polymeric material. The marking may be carried out during a regular production process not requiring the use of additional processing steps.

In another non-limiting example, the marking composition may be added as a powder or liquid via a standard feeder to an extrusion process. In another non-limiting example, the marking composition may be added to the recyclable polymeric material in a molding process. The marking composition and/or the marker/taggant materials may be configured to implement a durable marker, which is to be understood here as a marker which is able to withstand various production and/or recycling processes and remain within the recyclable polymeric material. Such durable marking composition may be added earlier in the production process of the recyclable polymeric materials, for instance before or after a verbund process e.g., together with live feedstock chemical building blocks, or at the monomer stage, or during the production of raisings or pellets. A durable marking composition will remain within the recyclable polymeric material in the finished product made therefrom, and after it is recycled one or more times.

The marker/taggant materials and/or marking compositions may be applied to or embedded in a wide set of recyclable polymeric materials and products. In a non-limiting example, the technique of the present application may be used to mark, trace manage, tokenize, and/or quality supervise/monitor, recyclable polymers, polycondensates, polyadducts, and modified natural polymer substances.

One way to overcome the problem of recycling a possibly multi-material plastic products is to produce products from a single material (possibly with additional additives in low concentration). This may be possible as polymeric materials may be produced by different production processes providing the various products or components of products with different forms and properties required. The reuse of material recycled from a single material product may have the disadvantage that the recycled material may be of lower quality due to, for example, degradation caused by the recycling process. Products produced from recycled materials may be used for producing the same product only a limited number of times, after which it may be used for different product(s) requiring polymeric materials with lower quality or different concentration of additives. Alternatively, polymeric material recycled for a preselected number of times may be diverted to undergo a different recycling process (e.g., a chemical recycling wherein the recycled material is converted into monomers, oligomers and higher hydrocarbons that can be used to produce virgin-like polymers).

The marking, segregation and recycling techniques disclosed herein are used in some embodiments for quality monitoring/supervising and/or tokenizing recyclable materials e.g., utilizing digital currency, such as the cryptocurrencies used in virtual coin systems. This way, a preselected quantity (e.g., measured in volume or weight) of recyclable materials carrying the marker/taggant materials disclosed herein, may correspond to a virtual currency (and/or quality indicating score/grade), which may be recorded on a database e.g., a distributed computer database on a data network, such as the Internet. In a non-limiting example, the database may be a type of cloud-based database system. More specifically, the database may be a type of blockchain system, wherein various parties manage a consensus-based ledger. The techniques disclosed herein enables the encoding of any type of information into the marked materials. This information may be read by a suitable reader and interpreted and then stored, presented or used by the cloud-based system.

This way, the virtual currency used for the tokenization of the recyclable material can be used as a tool for managing the life cycle of various recyclable materials, wherein preselected amount of a virtual currency is created and/or transferred between parties as recyclable materials are produced, used as intermediate materials in the production of other materials and products, change hands along the supply chain, reused, recycled, incinerated or buried in landfills.

In a non-limiting example, the virtual currency may correspond to/tokenize plastic, its production, use, reuse, and recycling. The virtual currency may be used to manage a credit system for the production and introduction of new (virgin) plastic Vs. the reuse, incineration, and in general, to give incentive to reduction of disposal of plastic waste and to the reduction in environment damage. For this purpose, one or more marker/taggant materials may be introduced into a plastic product during the production process of the plastic materials, and/or during by various manufacture techniques, such as, but not limited to, extrusion, molding, injection and other forming methods.

Optionally, but in some embodiments preferably, the durable marking composition is introduced into the plastic product, such that after the marker/taggant material is embedded in the bulk of the material of the plastic product, it remains within the plastic product throughout its entire life-cycle, from the production and up to the recycling facility. The durable marking composition can comprise marker/taggant materials which are resistant to temperature, pressure and/or various solvents, such that they remain in the recyclable materials during and after being subject to recycling process(es). Such resistant marker/taggant materials may be also introduced to a raw material (e.g., resin) and remain therein after being subject to various production processes e.g., polymerization, extrusion, or suchlike.

As such a marked recyclable material progresses through a production and supply chain, the marker/taggant materials introduced thereinto are detected in various stations/facilities of the production/supply chain, and the parties/entities using the material, or a product made therefrom, may be required to make a transfer of a corresponding virtual currency, according to the amount of the recyclable material produced or used. On the other hand, a party/entity which removes the marked recyclable material form the environment, for example, by taking the recyclable material from a recycling facility, or from landfill, for reuse, incineration and/or composting, may receive an amount of virtual currency according to the amount of recyclable material removed.

In an example, one or more markers are introduced into a material in one preselected facility/station. In another example, one or more markers are introduced to the material in a plurality of facilities. For example, a marker may not survive certain production or recycling process. In such a case similar, or different markers, may be applied or introduced into the material during or after such processes, as exemplified in the figures and described in detail hereinbelow.

One inventive aspect of the subject matter disclosed herein relates to a method of managing production and reuse of a recyclable material. The method comprising introducing a combination of markers into one or more ingredient material components of the recyclable material, where the combination of markers being indicative of one or more properties of at least one of the ingredient material components comprising at least a type of material used and percentage thereof in the recyclable material, processing a signal obtained from a product comprising the recyclable material and detecting presence of the combination of markers therein, and determining based on the detection of the combination of markers information indicative of the one or more properties, and based on the information deciding either about a suitable recycling process for reusing the at least one ingredient material component or a suitable disposal process for disposing the product.

In some embodiments the one or more properties of the at least one ingredient material component comprises at least one of the following: weight of the ingredient material component; a number of recycling processes the at least one ingredient material component undergone; a manufacturer of the at least one ingredient material component, and/or a manufacturer of a product comprising the at least one ingredient material component. The processing of the signal obtained from the product can comprise determining concentration of at least one of the markers and/or a ratio thereof, and based thereon determining concentration and/or ratio of at least one of the ingredient material components in the recyclable material, and/or concentration and/or ratio of the at least one ingredient material component to be used for producing of a new recyclable material or a new product therefrom.

The method comprises in some embodiments introducing the combination of markers into the one or more ingredient material components of the recyclable material during at least one of the following: processing of row materials of at least one of the ingredient material components; production of raisings or pellets comprising the recyclable material; extrusion, pultrusion, molding and/or forming process applied to said recyclable material; production of the product comprising the recyclable material; use of the product comprising the recyclable material; and/or recycling of the product comprising the recyclable material.

Optionally, but ins some embodiments preferably, the deciding about the disposal process comprises segregating the product based on the processed signal either for landfill disposal, incineration, or composting. The deciding about the suitable recycling process can comprise determining based on the determined information a percentage of the at least one ingredient material component from the product to be used in production of a new recyclable material therefrom. Additionally, or alternatively, the deciding about the suitable recycling process can comprise determining based on the determined information between a mechanical and chemical recycling process, and/or a percentage of combined recycled and virgin materials used in said suitable recycling process.

The method comprises in some embodiments introducing one or more additional markers into new recycled material recycled from the product. The one or more additional markers can be indicative of one or more properties of a recycling process used to recycle said product. The one or more properties of the recycling process used to recycle the product can comprise at least one of the following: a recycler producing the new recycled material recycled from the product; a percentage of the at least one ingredient material in the new recycled material recycled from the product; and/or a percentage of virgin material in the new recycled material recycled from the product.

The introducing of the combination of markers comprises in some embodiment: introducing a first marking composition to at least one of the one or more ingredient material components during production thereof, where the first marking composition being indicative of at least one of a type of material comprised in the at least one ingredient material component, a manufacturer of the at least one ingredient material component, and a percentage of the at least one ingredient material component in the recyclable material; and introducing a respective additional marking composition during, or after, each recycling process involving the at least one ingredient material component, where the respective additional marking composition being indicative of at least one of the following: a number of recycle processes the at least one ingredient material component undergone; a recycling process carried out using the at least one ingredient material component; a recycler carrying out the recycling process; a percentage of the at least one ingredient material component in a newly recycled material produced by the recycling process; and/or a percentage of virgin material in the newly recycled material.

The method can comprise using the information determined based on the detection of the presence of the combination of markers and/or the additional marking compositions to determine at least one the following: at least one production process carried out using the at least one ingredient material component; at least one recycling process carried out using the at least one ingredient material component; the number of recycle processes carried out using the at least one ingredient material component. The method can further comprise deciding based on the determined information about either a suitable recycling process for reusing the at least one ingredient material component, or a suitable disposal process for disposing the product. The deciding about the suitable recycling process can comprise deciding whether to use a newly recycled material comprising the at least one ingredient material component for production of either a new or same product.

Optionally, at least one of the markers and/or the marking compositions is a non-durable marker configured to be substantially removed, decomposed, and/or become unreadable, due to production and/or recycling processes involving said at least one ingredient material component. Alternatively, or additionally, at least one of the markers and/or the marking compositions is a durable marker configured to remain within the recyclable material along all production and/or recycling processes performed throughout its entire life-cycle.

Alternatively, or additionally, at least one of the markers and/or the marking compositions is a semi-durable marker configured to partially withstand production and/or recycling processes involving the at least one ingredient material component and thereby diminish its concentration therein. The processing of the signal obtained from the product can comprise determining the concentration of the semi-durable marker, and based thereon determining whether the at least one ingredient material component undergone recycling. Optionally, the determining of the concentration of the semi-durable marker comprises determining the number of recycle processes which the at least one ingredient material component undergone.

The processed signal can be used for tracing, production management, tokenization, and/or quality supervision/monitoring, of the at least one ingredient material component of the recyclable material. Optionally, the product is a type of smart product, and the information encoded by the markers and/or the additional marking composition(s) can be uploaded to, stored in, or processed by the smart product.

The processing of the signal obtained from the product comprises in some embodiments determining a composition of materials included in said product. The method can further comprise determining relative concentrations of the materials of the composition of materials based on the processing of the signal.

The method comprises in some embodiments recording in a database a record associated with at least one of the markers information indicative of the one or more properties of the of at least one ingredient material component, and/or a recycling process thereof. The method can further comprise: collecting waste products and processing a signal obtained from each one of the waste products for determining presence or absence of at least one of the markers or the additional marking compositions; segregating each of the waste products based on the processed signal obtained therefrom; and deciding based on the processed signal and information from the associated database record about either a suitable recycling process for reusing the at least one ingredient material component, or a suitable disposal process for disposing said product.

The recyclable material comprises in some embodiments at least one polymer and/or bio-based component material. Optionally, but in some embodiments preferably, the markers comprise at least one UV, XRD or XRF marker.

The method comprises in some embodiments crediting based on the determined information at least one of the following: a manufacturer of at least one of the ingredient material components, a manufacturer of products comprising the recyclable material, a recycler of the products, a consumer of the recyclable material or the products, an aggregator of waste products comprising the recyclable material or the products, and/or an incinerator of waste products comprising the products.

Another inventive aspect of the subject matter disclosed herein relates to a system for managing production and reuse of a recyclable material. The system comprising: at least one reader configured to measure a signal from an inspected object, where the measured signal being indicative of presence or absence of a combination of markers in the inspected object; and at least one processing unit configured and operable to process the measured signal from the at least one reader, detect presence of the combination of markers information in the inspected object and determine based thereon information indicative of one or more properties of at least one ingredient material component of a recyclable material comprised in the inspected product, and decide based of the determined information either about a suitable recycling process for reusing the at least one ingredient material component or a suitable disposal process for disposing the product. The at least one processing unit can be configured and operable to determine based on the determined information at least one of the following: weight of said ingredient material component; a number of recycling processes said at least one ingredient material component undergone; a manufacturer of said at least one ingredient material component, and/or a manufacturer of a product comprising said at least one ingredient material component.

Optionally, but in some embodiments preferably, the at least one processing unit is configured and operable to determine based on the determined information concentration of at least one of the markers and/or a ratio thereof, and based thereon determining concentration and/or ratio of at least one of the ingredient material components of the recyclable material, and/or concentration and/or ratio of the at least one ingredient material component to be used for producing of a new recyclable material or a new product therefrom. The system comprises in some embodiments a segregating system, and the at least one processing unit can be configured and operable to decide based on the determined information whether to segregate the product for landfill disposal, incineration, or composting.

The at least one processing unit can be configured and operable to determine based on the determined information a percentage of the at least one ingredient material component from the product to be used in production of a new recyclable material therefrom in the determined suitable recycling process.

The system comprises in some embodiments a mechanical recycling system or a chemical recycling system. The at least one processing unit can be configured and operable to decide based on the determined information whether to use in the suitable recycling process the mechanical recycling system or the chemical recycling system, and/or a percentage of combined recycled and virgin materials used in the suitable recycling process.

The at least one processing unit can be configured and operable to detect presence or absence of one or more additional marking compositions in the measured signal, and determine based on the presence of the one or more additional marking compositions information indicative of one or more properties of a recycling process used to recycle the product. The one or more properties of the recycling process used to recycle the product can comprise at least one of the following: a recycler producing the new recycled material recycled from the product; a percentage of the at least one ingredient material in the new recycled material recycled from the product; and/or a percentage of virgin material in the new recycled material recycled from the product.

The at least one processing unit can be configured and operable to determine based on the determined information at least one of the following: a type of material comprised in the at least one ingredient material component; a manufacturer of the at least one ingredient material component; a percentage of the at least one ingredient material component in the recyclable material; a number of recycle processes the at least one ingredient material component undergone; a recycling process carried out using the at least one ingredient material component; a recycler carrying out the recycling process; a percentage of the at least one ingredient material component in a newly recycled material produced by said recycling process; and/or a percentage of virgin material in the newly recycled material.

Optionally, at least one of the markers or the marking compositions is either: a durable marker configured to remain within the recyclable material along all production and/or recycling processes performed throughout its entire life-cycle; a non-durable marker configured to be substantially removed, decomposed, and/or become unreadable, due to production and/or recycling processes involving the at least one ingredient material component; or a semi-durable marker configured to partially withstand production and/or recycling processes involving the at least one ingredient material component and thereby diminish its concentration therein. The at least one processing unit can be configured and operable to determine the concentration of the semi-durable marker, and based thereon determining whether the at least one ingredient material component undergone recycling.

The system comprises in some embodiments a database. The at least one processing unit is configured and operable in some embodiments to store in a record associated in the database with at least one of the markers information indicative of the one or more properties of the of at least one ingredient material component, and/or a recycling process thereof.

The system comprises in some embodiments a segregation system. The at least one processing unit is configured and operable to process signals obtained from waste products processed by the segregation system and determine based thereon presence or absence of at least one of the markers or the additional marking compositions for operating the segregation system based on the processed signal and information from the associated database record to direct each of the waste products either to a suitable recycling process for reusing the at least one ingredient material component, or to a suitable disposal process for disposing the product.

Another inventive aspect on the subject matter disclosed herein related to recyclable material comprising one or more ingredient material components and a combination of marking compositions indicative of one or more properties of at least one of the one or more ingredient material components. The combination of marking compositions can be configured for detection by a reader device for determining information indicative of at least one of the following: weight of the at least one ingredient material component; a type material of the at least one ingredient material component; number of recycling processes of the at least one ingredient material component; a manufacturer of the at least one ingredient material component; a percentage of the at least one ingredient material component in the recyclable material; a recycling process carried out using the at least one ingredient material component; a recycler carrying out the recycling process; a percentage of the at least one ingredient material component in a newly recycled material produced by the recycling process; and/or a percentage of virgin material in the newly recycled material. The one or more marking compositions can comprise at least one of a durable, semi-durable, and/or non-durable marker/taggant materials.

A yet another inventive aspect of the subject matter disclosed herein relates to a product comprising the recyclable material disclosed hereinabove or hereinbelow. The product is operable for inspection by a reader device for detection of the combination of marking compositions. The product can be a type of smart product configured to upload, store, and/or process the information encoded by the markers and/or the additional marking composition(s).

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIG. 1 schematically illustrates life cycle and recycling of recyclable materials/products;

FIG. 2 schematically illustrates a recycling process according to some possible embodiments;

FIG. 3 schematically illustrates production of polymer materials according to some possible embodiments;

FIG. 4 schematically illustrates production of compostable polymer materials according to some possible embodiments;

FIGS. 5 and 6 schematically illustrate recycling processes according to other possible embodiments;

FIGS. 7 and 8 schematically illustrate respectively a monitoring scheme usable for quality monitoring/supervising and/or tokenization of recyclable materials, and a specific example, according to possible embodiments; and

FIG. 9 is a flowchart demonstrating lifecycles of recyclable materials according to some possible embodiments.

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practised without such specific details. In an effort to provide a concise description of these embodiments, not all features or details of an actual implementation are described at length in the specification. Emphasis instead being placed upon clearly illustrating the principles of the invention such that persons skilled in the art will be able to make and use the tagging/marking, segregation, tokenizing/quality grading/monitoring and recycling, once they understand the principles of the subject matter disclosed herein. This invention may be provided in other specific forms and embodiments without departing from the essential characteristics described herein.

The present application provides a novel technique for managing and/or tokenizing/quality monitoring the recycling and the various life-cycles of recyclable materials and products made of recyclable materials, such as, but not limited to, single material products (i.e., products made of a single polymeric material with possibly additional low concentration additives). To this end, a first marking composition (e.g., including one or more marker/taggant materials) may be added to the polymeric material during production. In a non-limiting example, the marking composition is added during the production of polymeric resins or pellets to be used in techniques such as extrusion, molding and/or forming, in the productions of a plastic product. In a different non-limiting example, the marking composition may be added in the production process of the product itself. For instance, it can be added via a standard feeder (e.g., with additional additives in a masterbatch) to processes such as extrusion and molding.

In a further non-limiting example, the marking composition may be added in the production of building blocks of the polymeric material. For example, certain marking compositions may be added to the reaction in which the monomers are produced. This first marking composition may be detected at any stage of the production and in the finished product by a reader device e.g., optical reader. For example, and without limiting, if XRF marker/taggant materials are use, during the recycling process of such products the marking composition may be detected and identified by an XRF reader (e.g., a mobile handheld reader), thereby providing an indication that the recycled product is made of virgin (i.e., non-recycled material) and therefore may undergo one of preselected recycling processes, and/or used in the production of one or more products for which a once-recycled material may be a suitable ingredient.

During, or after, the recycling process a second marking composition may be added to the polymeric material, such that the once recycled polymeric material may be identified by reading the second marking composition. This recycling and marking process may repeat itself a number of times, such that prior to each recycling of a product the added marking composition is identified, thereby indicating the exact number of times, and possibly the types of recycling processes, the polymeric material has undergone, which can be then used for determining future uses of the recycled material.

Accordingly, the different marking compositions added to the virgin material, and to each subsequent recycling process are used as a counter for counting the number of times the polymeric material was recycled. Furthermore, the latest marking composition added at the latest recycling process may also indicate the entire history of the recycled material. Namely, lastly added marking composition can be used to determine the exact production, and recycling processes the recycled material underwent, and possibly additional information (the different products for which it was used, the producers and more).

The information encoded in a product by the added marker/taggant materials may be uploaded (for example by the readers or by other devices) and stored in a cloud system. The cloud system may be used to manage ‘green’ credit system for the manufacturers of various recyclable products, the manufacturers of various polymeric materials used in a production process, suppliers of such products, and the end users. In an example the cloud system may be a distributed blockchain system. For example, the blockchain systems described in international patent publication Nos. WO 2018/207180, and WO 2019/175878, and U.S. provisional patent application No. 62/913,548, of the applicant hereof, the disclosure of which are incorporated herein by reference.

In some possible embodiments the marker/taggant material may be incorporated in a smart product (intelligent product having processing, sensing, and/or communication abilities), and the information encoded by the marking composition(s) may be uploaded to, stored in, or processed by electronic systems (a chip, a memory device, or a processor) of the smart product. In a non-limiting example, the smart product is a smart garment, or a smart shoe (e.g., trainer), in which such electronic systems are incorporated, for example, as flexible circuit. The electronic system and their components may also be marked by one or more marking compositions which may be read by the same readers as the product itself, for example the smart garments and electronic systems described in international patent publication No. WO 2017/175219, of the same applicant hereof, the disclosure of which is incorporated herein by reference. The smart garment may store and process information received from the reader of the marking composition(s), as well as from other sources. The smart garment or shoe may also interact with a cloud system or a blockchain system.

In an alternative example a semi-durable marking composition is embedded within the polymeric material only once. The semi-durable marking composition is configured such that it does not fully withstand the recycling process e.g., causing it to decompose, become neutralized, and/or lose/diminish its marking properties and/or readability. For example, in some possible embodiments the marking composition(s) may fully or partially dissolve in a chemical recycling process, which may involve the use of one or more organic solvents. In such embodiments, after undergoing a recycling process, at least a portion of the marking composition(s) will dissolve, lowering its concentration in the recycled polymeric material. Measuring the concentration of the marking composition (e.g., at the recycling facility prior to recycling) will thus provide an indication whether the material of a recycled product has already undergone recycling or not, and moreover, may also indicate the number of cycles (i.e., the number of recycling processes the material has undergone).

In another non-limiting example, a recyclable product may contain two components (ingredient materials), wherein the recycling process of one, or both, of the ingredient materials include a process for separation of the two materials. Such separation process may wash away or remove one of the ingredient materials. A marking composition may be included within one or both of the ingredient materials. A marking composition marking the ingredient material which is removed may be also removed with it by the separation process, while the marking composition embedded in the remaining ingredient material may be resistant to the separation process, and thus remain within the remaining ingredient material.

In another non-limiting example, the marking composition of the remaining ingredient material may be a semi-durable marking composition, that is not fully resistant to the separation process, such that the concentration of the marking composition decreases with each separation process. For instance, the two-component product may be a fabric or a yarn comprised of two types of fibers made of different ingredient materials. One possible example of such two-component product is fabric of nylon-lycra blend, wherein the lycra ingredient component may be removed by a heat treatment (at 220° C. temperature) followed by treatment with ethanol, while the nylon ingredient component retains its original morphology. A marking composition embedded in the nylon ingredient component will therefore remain, fully or partially, in the recycled nylon after separation from the nylon-lycra blend. Identifying the marking composition prior to, or after, recycling may further provide information regarding the original product (the fabric) being recycled, the manufacturer of the original product, and the recycling process(es) involved therewith so far.

In yet another non-limiting example, a product made of a single polymeric material may be a shoe such as a trainer, which may be made of elastic materials, such as, but not limited to, thermoplastic polyurethane. The midsole may be made of TPU-based foam while the upper part of the shoe may be made of a TPU-based yarn. A shoe made from a single thermoplastic material may be recycled for instance by a mechanical process, for example, by grinding the shoe into fine pellets and then melting the pellets to obtain the TPU in a form from which similar shoes can be manufactured again. The recycling process however may affect some of the properties of the shoe. For example, a recycled material may have degraded mechanical properties. Therefore, after a certain number of recycling cycles the recycled material may be used to manufacture a different type of shoes, or a different type of product. With the techniques disclosed herein, marking composition(s) may be introduces into the virgin thermoplastic material of the shoe e.g., during the production of the shoe and/or its ingredients, and then optionally in each recycling cycle to be used as a counter for counting the number of recycling processes the shoe material has undergone according to the reduction in potency and/or concentration of the marking composition(s) reflected by the signals measured by the reader.

The present application also provides techniques for determining the ratio of virgin material vs. recycled material in a recycled material e.g., used in a production process of a new product. By marking a recycled material with a durable or semi-durable marker/taggant material, one is able to determine the percent/amount of recycled material that is blended or combined with virgin material in the production of a new object/product. Moreover, measuring the number of cycles of recycling an ingredient component material has undergone enables a manufacturer to improve and optimize the manufacturing process in accordance with the quality of the recycled ingredient component material(s), which may depend on the number of recycle processes the ingredient component material undergone.

The present application also provides techniques for managing the life-cycle of recyclable ingredient component materials, including recycling and reuse of multi material plastic products. This is achieved in some embodiments by introducing a preselected marking composition to each, or to some, of the polymeric materials from which a multi-material product is made of. Each such marking composition may include one or more different marker/taggant materials, each corresponding to the specific ingredient component material it is marking. Thus, the preselected marking compositions added to their respective ingredient component materials enables the identification of the composition/mix of polymeric materials included within the final product with a suitable reader.

In a non-limiting example, the specific selection of marking compositions corresponds to a particular product comprising the respective ingredient component materials, such that identifying the set of marking compositions included within the ingredient component materials completely identifies the composition of polymeric materials included in the product and their relative concentrations within the product. For example, the different selections of marking compositions and the corresponding products in which they are embedded, may be stored in a database (e.g., a cloud-based database) configured to enable such identification.

In another non-limiting example, the reader may also measure the concentrations, and/or relative concentrations, of the different marking compositions in a product material, thereby allowing the identification of the composition and relative concentrations of the polymeric ingredient component materials within the product, even without prior knowledge regarding the product it self. A measurement of the different concentrations (or relative concentrations) of the marking compositions may be realized by XRF analysis allowing such measurement of XRF marker/taggant materials (e.g., by using mobile or benchtop EDXRF reader).

A product comprising various parts, wherein each part is made of different polymeric ingredient materials, and wherein each polymeric ingredient material is marked by a different marking composition, may be examined at a recycling facility by a reader configured for detecting and identifying the various polymeric ingredient materials comprised in the finished product. Once identified, the different parts may be diverted, each to a suitable recycling process, according to its polymeric ingredient materials.

In addition, the final product may consist of, or include, one or more parts, which are made of compositions, each including more than one polymeric ingredient material. At a recycling facility the product may be examined by a reader for identifying the one or more compositions, and diverting each part to a suitable recycling process according to its polymeric ingredient materials. During or after the recycling process of each polymeric ingredient material, or a composition of materials, a new marking composition may be added to the recycled ingredient material, or composition of recycled ingredient materials. This new marking composition may be used as a counter counting the number of recycling cycles the ingredient material, or composition of ingredient materials, has undergone.

The marking composition(s) used in the different embodiments disclosed herein may encode additional information, such as, but not limited to, the manufacturer of the ingredient material or the final product, the manufacturer of the future product to be made from the recycled material, and more.

The introduction of marking composition(s) into recyclable material components, and/or final products made therefrom, as disclosed herein, is used in some embodiments to tokenize the, and/or monitor quality of, recyclable materials and/or products during their production, segregation, recycling, and/or after disposal thereof. Accordingly, in some embodiments, a manufacturer using a certain amount of recyclable material carrying the marker/taggant materials disclosed herein, may receive a corresponding amount of virtual currency, which may be credited to the manufacturer in a virtual coin system. The incineration or composting of the marked recyclable material, for reduction of environmental damage, can similarly provide a certain amount of virtual currency credited to the respective party/entity, according to the amount of recyclable material removed from the environment.

A common type of multi-material plastic products is plastic laminates used in the packaging industry for various types of packages and wrapping. A plastic laminate may include several layers, each layer including one or more ingredient materials, and is usually regarded as unsuitable for recycling. Marking the ingredient components of a plastic laminate, and detecting them during, or before, recycling in accordance with the techniques disclosed herein, will enable the recycling of such multilayered laminates.

For an overview of several example features, process stages, and principles of the present application, the tagging/marking examples illustrated schematically and diagrammatically in the figures, and described hereinbelow, are intended for plastic products. These tagging/marking techniques are shown as one example implementation that demonstrates a number of features, processes, and principles used to facilitate marking of ingredient plastic materials, but they are also useful for other applications and materials, and can be made in different variations. Therefore, this description will proceed with reference to the shown examples, but with the understanding that the invention recited in the claims below can also be implemented in myriad other ways, once the principles are understood from the descriptions, explanations, and drawings herein. All such variations, as well as any other modifications apparent to one of ordinary skill in the art and useful in materials recycling applications may be suitably employed, and are intended to fall within the scope of this disclosure.

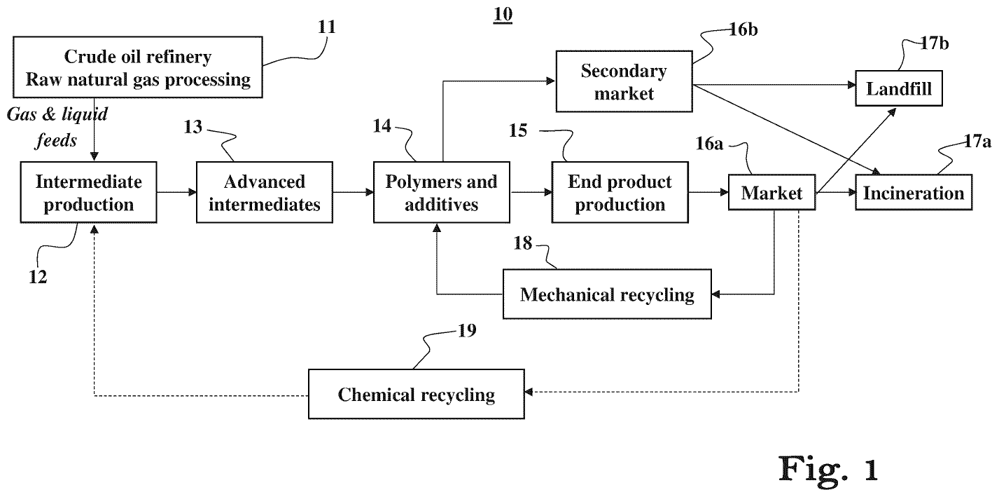

FIG. 1 is a block diagram (10) schematically illustrating life cycle and recycling of plastic products. Manufacture of plastic products may start in intermediate production (12) of the petrochemical components. The intermediate production (12) may utilize only virgin materials, such obtained from crude oil and natural gas processing (11). Alternatively, the intermediate production (12) may utilize recycled components, such as obtained from a chemical recycling process (19). Advanced intermediates (13) obtained can be then used for polymer production (14), and introduction of additive material, as may be required. The polymer production (14) stage may use only virgin materials obtained from the intermediate and advanced production steps (12, 13). Alternatively, the polymer production (14) stage can also use recycled ingredient components obtained from a mechanical recycling process (18).

The polymer material can be then used for manufacturing a specific end product (15) for commerce in respective marketplaces (16a), and/or for other products related to secondary markets (16b). After use of the manufactured products terminates, some portion of the used products are typically disposed for landfill (17b) or incineration (17a), and some portion undergo segregation for reuse. The reuse of the disposed products can be achieved by the mechanical recycling process (18), which provide ingredient components materials to the polymeric and additive production stage (14), or by the chemical recycling process (19), which provide decomposed components materials to the intermediate production stage (12).

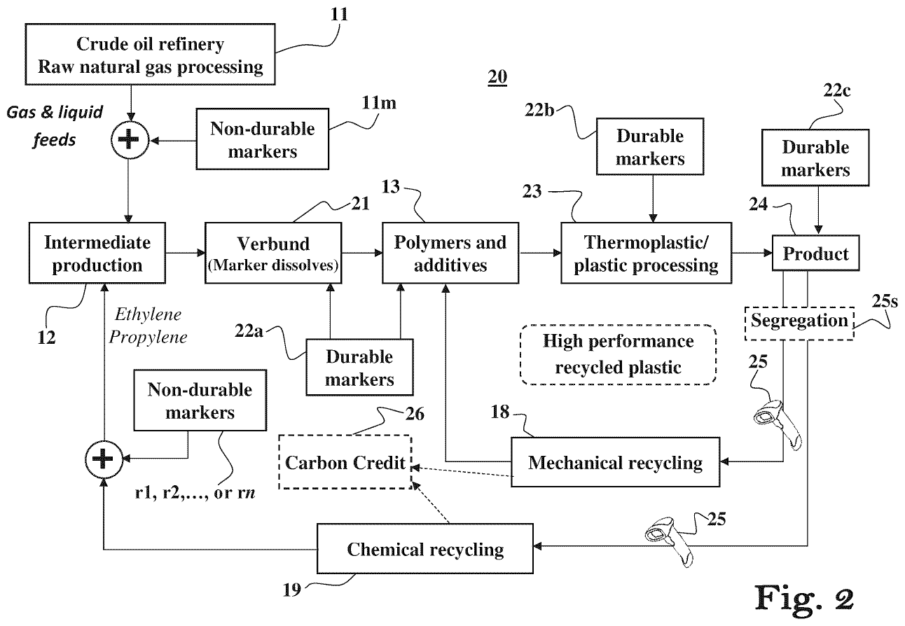

FIG. 2 schematically illustrates production, segregation and recycling, processes (20), according to some possible embodiments, wherein durable and/or non-durable (and/or semi-durable) marker/taggant materials are added to the component materials. Optionally, but in some embodiments preferably, non-durable (and/or semi-durable) marker/taggant materials (11m) are added in the intermediate production stage (12) to the crude oil and/or raw natural gas processing (11). Such non-durable (and/or semi-durable) materials (11m) are configured to be affected by the recycling processes of the produced component materials by the reduction in their potency and/or concentration, to thereby provide a measure of the number of recycle processes applied to the component material.

For Example, but without limiting, in a chemical recycling process according to possible embodiments the non-durable materials (11m) can comprise metal compounds, for example metal oxides, and metal sulfates. The semi-durable materials in a chemical recycling process according to possible embodiments can comprise metal chlorides, metal carbonyls, acetylacetonate (acac), trifluoroacetylacetonate (tfac) and hexafluoroacetylacetonate (hfac). In a non limiting example the durable materials used in a chemical recycling process can be metal phthalocyanine.

The advanced intermediate component can be obtained in some possible embodiments by a Verbund process (21), in which the non-durable materials (11m) may be dissolved in the produced component material, which is used in the polymer production stage (13) to produce polymers using optional additives, and/or recycled component materials from the mechanical recycling process (18).

The Verbund process creates efficient value chains that extend from basic chemicals all the way to consumer products. This process typically consists of several steps wherein: long hydrocarbon chains are first mixed and evaporated with water vapors, which are then heated to cause the naphtha to break down into smaller components, the hot gas obtained is very rapidly cooled immediately afterwards, to thereby prevent the cleavage products from breaking down further. The crude gas is then compressed. The first products formed as a result of these process steps, for example pyrolysis oil and pyrolysis gasoline. Finally, the products contained in the mixture formed are further separated from each other by distillation, to obtain basic components for subsequent production which include primarily ethylene, propylene, butadiene, pyrolysis gasoline and hydrogen.

A durable marker/taggant material (22a) can be added to the produced material component in the advance intermediate stage, in this non-limiting example Verbund processing (21), and/or in the polymers and additives production process (13). The durable marker/taggant material (22a) is configured to substantially withstand separation and recycling processes and maintain its potency, and thus can be used as a permanent marker that can be used to trace and identify the manufacture processes, the percentage of recycled component materials added in the production process, and/or the manufacturer, of the ingredient component material carrying the durable marker(s) (22a).

After the polymer and additives stage (13), the produced ingredient component material undergoes thermoplastic/plastic processing (23) for manufacturing final products, and/or parts for final products, therefrom. In this stage other durable markers (22b) may be introduced, serving as permanent markers for identifying the specific thermoplastic/plastic process(es) used in the production (e.g., molding, extrusion, pultrusion, etc.). The final product obtained (24) using one or more ingredient components materials produced based on this process (20) can be also marked by applying durable marker(s) (22c) e.g., by printing or coating, usable for identifying the specific product, or product part (24), manufactured form the produced ingredient component material.

After the end products (24) comprising the one or more of the markers (11m, 22a, 22b, and/or 22c) are disposed, their ingredient component materials, manufacturer, manufacture processes, and/or specific final products, can be identified in a segregation process (25s) utilizing one or more reader devices (25) configured to detect the different types of markers added during the production process (20). The segregation process (25s) can be used to determine, based on the markers detected by the readers (25), whether waste products, or one or more parts thereof, can be reused utilizing the mechanical recycling process (18), or decomposed by the chemical recycling process (19). Based on the markers detection provided by the readers (25) carbon credit (26 i.e., greenhouse gas emission permit) can be provided to the manufacturer of the recycled ingredient component material e.g., based on the detection of the durable markers (22a, 22b, and/or 22c).

Optionally, but in some embodiments preferably, ingredient component materials obtained by the chemical recycling process (19) are marked by a cycle-specific non-durable marker/taggant material(s) (r1, r2, . . . , or rn) used as an indication of the number of chemical recycling processes the ingredient component material undergone. Particularly, if the readers (25) don't detect a cycle-specific non-durable marker/taggant material (r1, r2, . . . , or rn) in the used plastic product during the segregation stage (25s), then the used plastic product is sorted to undergo chemical recycling process (19) of used products containing only virgin ingredient component materials, whereby first cycle-specific non-durable marker/taggant material(s) (r1) is added to the recycled component materials to indicate that they undergone only one recycle process.

If the readers (25) detect the first cycle-specific non-durable marker/taggant material (r1) in the used plastic product during the segregation stage (25s), then the used plastic product is sorted to undergo chemical recycling process (19) of used products containing only ingredient component materials that were recycled at least once, whereby the first cycle-specific non-durable marker/taggant material(s) (r1) is decomposed/neutralized, and a second cycle-specific non-durable marker/taggant material(s) (r2) is added to the recycled component materials to indicate that they undergone at least two recycle process.

This cycle-specific non-durable marking process (r1, r2, . . . , or rn) can continue until the ingredient component material undergone a certain amount of permissible recycling processes, and marked by a final cycle-specific non-durable marker/taggant material (rn), indicating that the product(s) made therefrom should not be sorted in the segregation process (25s) to further chemical recycling processes (19). The product(s) made of ingredient component materials carrying the final cycle-specific non-durable marker/taggant material (rn) can be sorted by the segregation process (25s) for landfill or incineration disposal (17b and 17a in FIG. 1), or for a different recycling process e.g., mechanical recycling.

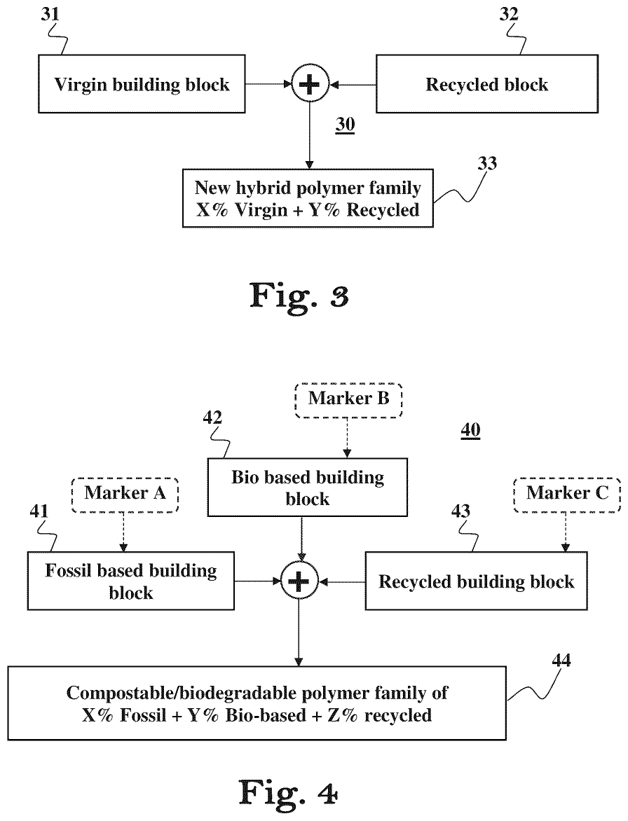

FIG. 3 schematically illustrate a production process (30) usable for combining a certain percentage (X %) of virgin component material (31) with a certain percentage (Y %) of recycled component material (32), to obtain a new hybrid polymer component material (33). The production process (30) can be used to guarantee that the combined material component obtained (33) satisfies quality conditions required for the production of the end products, due to the degradation of physical/mechanical properties of recycled materials. The process (30) can be thus configured to guarantee that the amount of virgin material (31) in the combined material component (33) is increased as the number or recycles processes of the recycled component material (32) is increased. The process (30) can be adjusted to further combine different percentages of a number of different recycled component materials (32) to the virgin component material (31), wherein each recycled component material (32) undergone a different number of recycle process, and wherein the percentage (X %) of virgin component material (31) is accordingly adjusted.

FIG. 4 schematically illustrates a production process (40) utilizing marker/taggant materials to permit accurate identification of ingredient component materials. In this specific and non-limiting example a new composite material (44) is produced from the combination of a certain percentage (X %) of virgin component material (41) to which a first marker/taggant material (Marker A) was added, together with a certain percentage (Y %) of a bio-based component material (42 i.e., comprising biological material e.g., “BioPE” or “BioPET”) to which a second marker/taggant material (Marker B) was added, and with a certain percentage (Z %) of recycled component material (42) to which a third marker/taggant material (Marker C) was added.

The production process (40) can be configured to assign for each ingredient component material (41, 42 and 43) a specific marker/taggant material (Marker A, B and C) indicative of the specific type of ingredient component material and its specific percentage (X %, Y % and Z %), or of a certain range thereof. Alternatively, or additionally, the amount of marker/taggant material (Marker A, B and C) added to each ingredient component material (41, 42 and 43) can be used as an indication of the percentage of (X %, Y % and Z %), or of a certain percentage range, for each of the ingredient component materials (41, 42 and 43) combined. This way, the new biodegradable polymer (44) obtained can be composed with a set of distinguishable markers allowing accurate identification of all its component ingredients, and their accurate percentage (or percentage range) therein.

The durable, semi-durable, and/or non-durable, marker/taggant materials can be used, depending on the specific composite polymer material (44) produced, and its intended purpose and applications.

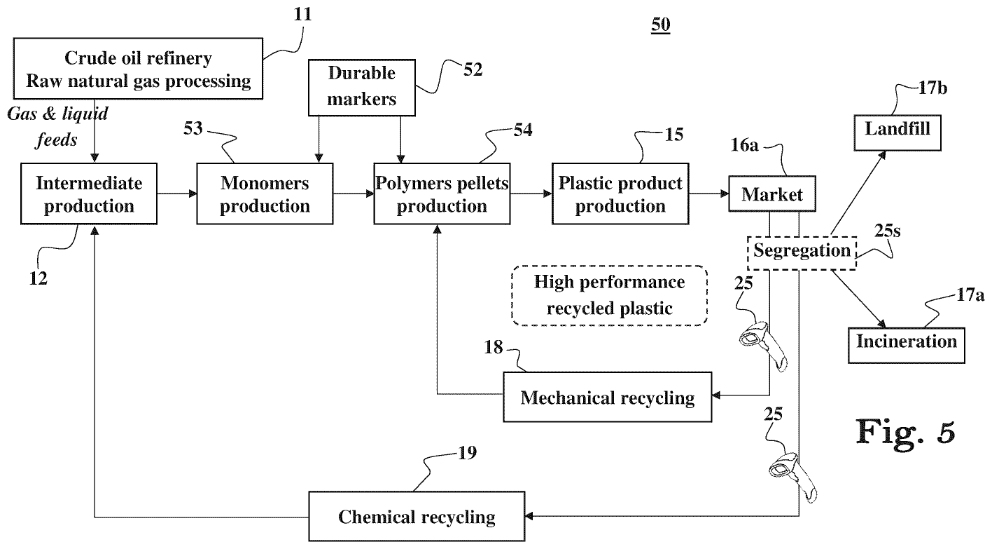

FIG. 5 schematically illustrates production, segregation and recycling, processes (50), according to some possible embodiments, having monomer production (53) and polymer pellets production (54) stages. In this non-limiting example, the process (50) includes stages for production of virgin material components from crude oil and/or natural gas (11) in the intermediate production step (12). Recycled material components from chemical recycling process (19) may be combine with the virgin material components. The material components produced in the intermediate production stage (12) are used for monomers production (53), and the monomers thereby produced are used for polymer pellets production (54). Durable marker/taggant material (52) can be added to the component materials at the monomer production stage (53), and/or the polymer pellets production stage (54).

End products are manufactured in plastic production stage (15) from the polymer pellets (54), and distributed to markets (16a) for commerce. After product use is terminated, the used products may be disposed and segregated (25s) for landfill (17b), incineration (17a), or recycle. Readers (25s) can be used in the segregation (25s) of the waste products to detect the marker/taggant materials (52), and based thereon decide whether to use mechanical (18) or chemical (19) recycling. If the marker/taggant materials (52) are detected by the readers (25), the disposed used/waste product will be decomposed utilizing the chemical recycle process (19). The waste products recycled by the mechanical recycling process (18) are reused for polymer pellets production (54), and the waste products recycled by the chemical recycling process (18) are decomposed for reuse in the intermediate production stage (12).

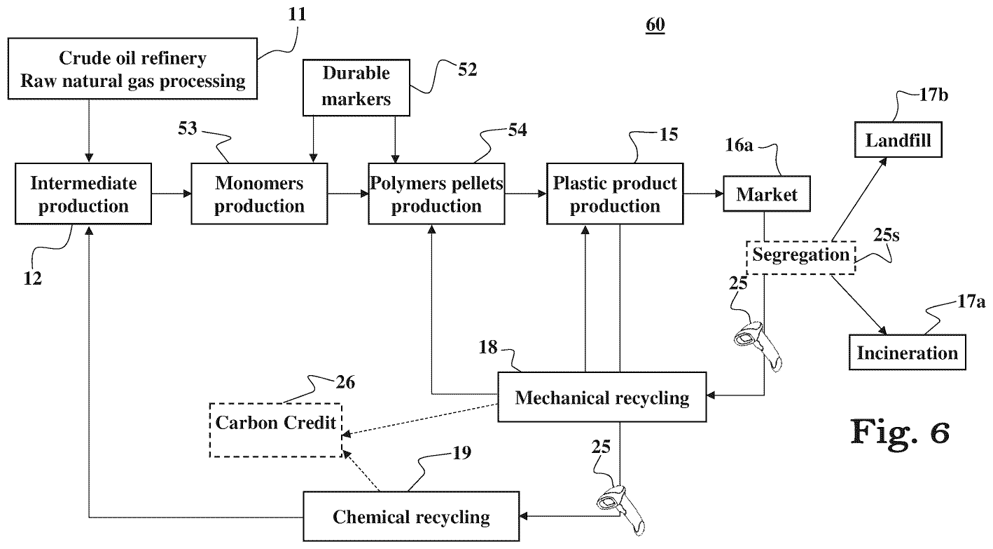

FIG. 6 schematically illustrates production, segregation and recycling, processes (60), according to some possible embodiments, having monomer production (53) and polymer pellets production (54) stages. Process (60) is substantially similar to process (50) shown in FIG. 5, but differs therefrom in that the segregation (25s) transfers the waste products either to landfill (17b) or incineration (17a) disposal, or to mechanical recycling (18), based on the detection of the marker/taggant materials (52) by the readers (25). After the mechanical recycling process (18), at least some portion of the processed waste products is sorted utilizing the readers (25) for recycling by the chemical recycling process (19), according to the marker/taggant materials therein detected. The mechanically (18) and chemically (19) recycled waste products can be used to provide carbon credit (26) to the manufacturers using the marking/tagging techniques disclosed herein, based on their detection by the readers (25).

Properties of the marking of recyclable materials, and the detection of the marker/taggant materials, disclosed herein, enables the management of an ‘economy’ for materials via the use of one or more virtual currencies. The properties of the marking schemes disclosed herein can be used to define the following operators (for a preselected quantity of marker/taggant material measured in a volume, or weight, of recyclable material):
Equality (′=′)—similar concentrations of the marker/taggant material will produce substantially the same/similar measured signal by the reader i.e., usable to indicate same/similar currencies. The equality property can be applied to marked recyclable materials, and/or their ingredient components, by adding the same marker/taggant material to two different marked recyclable materials such that their readings is equal (i.e., substantially same signals are measured by the reader), so an equal reading is obtained from these recyclable materials after the addition marker/tagg ant material.
Addition (′+′)—the amplitude of the measured signals responsive to the marker/taggant materials may be increased by raising its concentration. Thus, adding a certain amount of a marker/taggant material to a recyclable material will be reflected by a respective increase of the amplitude of the signal measured by the reader i.e., usable to indicate currency increase. Addition can relate to materials [A] and [B] carrying a marker/taggant material such that if reading([A])=reading([B]) i.e., reading from the materials measured by the reader, and [C] is another material carrying another marker/taggant material, then reading([A]+[C])=reading([B]+[C]) i.e., reading obtained from combinations of the materials [A] and [C], [B] and [C], as measured by the reader. Similarly,
subtraction (‘−’)—is obtained by lowering the concentration of the marker/taggant material in the recyclable material e.g., concentration can be lowered by diluting the marked material by adding unmarked material. Subtraction can relate to materials [A] and [B] carrying a marker/taggant material, where a specific amount/weight [C] is removed from them, such that if reading([A])=reading([B]) then reading([A]−[C])=reading([B]−[C]). Furthermore,
division (′r)—may relate to lowering the concentration to a preselected fraction/percentage relatively to an initial concentration e.g., if the material [A] carrying marker/taggant material is divided, for example, into two equal parts, then the readings obtained from these two equal parts is also same i.e., reading([A])/2=reading([A]/2).

Thus, a marker/taggant material “A” can be used to define an economy managing currency for the recyclable material, since the measured signals obtained by the readers responsive to its presence in the recyclable material obeys the following properties:
(i) it is reflective (A=A);
(ii)symmetric if A=B than B=A, with respects to a second marker/taggant material “B”) i.e., signals measurement indicating A≠B entail different currencies for the recyclable materials carrying marker/taggant materials “A” and “B”;
(iii) transitive (if A=B and B=C then A=C, with respect to a third marker/tagg ant material “C”);
(iv) commutative (A+B=B+A); and
(v) associative ((A+B)+C=A+(B+C)).

It thus follows that: if A=B then A+C=B+C; if A=B then A−C=B−C; and if A=B and C≠0 then A/C=B/C, for recyclable materials carrying marker/taggant materials “A”, “B” and “C”.

Accordingly, the marking compositions introduced into the recyclable materials, as disclosed herein, provides a measurable and objective measure, indicative of the recyclable material, which also supports the basic mathematic operators of addition (‘+’), subtraction (‘−’), division (‘/’) and equality (‘=’), and thus can be used to define immutable and trustable currencies (e.g., usable in a virtual coin system, such as a blockchain system).

It is thus possible to define various different currencies to predefined quantities of recyclable material carrying a specific marker/taggant material as a function of the properties of the marked recyclable material (“Item”) and the measured signals (“Marker”), as follows:

Currency=ƒ(Item properties, Marker).

In some embodiments, specific marker/taggant materials introduced into the recyclable materials are used to identify the specific manufacturer (producer) of the marked recyclable material, the type of material (MatType e.g., plastic type), the percentage/part (% recycled) of recyclable material combined in the produced marked recyclable material, and the number (loopCount) of recycling processes of the recyclable material combined in the produced marked recyclable material, the weight (or density) of the produced marked recyclable material. In some embodiments the above-indicated mathematic operators are quantitatively used only with the weight and % recycled parameters.

In this way, a respective currency can be specially defined for each party/entity (stakeholder) participating in life-cycles of recyclable materials, such as, but not limited to, the producer that manufactured the marked recyclable materials, the consumer purchased (or disposing as waste to the recycler, or to a waste facility) the produced marked recyclable materials, the waste collector handling the collection of disposed/used waste products made from the marked recyclable materials, and the recycler (and/or segregator) of the collected disposed/used waste products. In some possible embodiments these currencies are determined using the currency function defined in Table 1, below.

TABLE 1

| | | Currency/Coin (e.g., f uses |
|---|---|---|
| Stakeholder | Operation | operators “+”, “−”, “/”) |
| Producer | Produce | f_{producer}(weight, PlasticType, % |
| | | recycled, LoopCount) |
| Consumer | Buy | f_{cb}(weight, PlasticType, % |
| | | recycled, LoopCount) |
| Consumer | Return | f_{cr}(weight, PlasticType, % |
| | | recycled, LoopCount) |
| Waste | Collect | f_{wc}(weight, PlasticType, % |
| Collector | | recycled, LoopCount) |
| Recycler | Recycle | f_{recycler}(weight, PlasticType, % |
| | | recycled, LoopCount) |

It is noted that the currency functions defined in Table 1 can be equally used as quality grade/score indicators indicative of the quality of the recyclable material carrying the marking composition (marker/taggant materials). Optionally, the quality indication is indicative of an environment preservation quality/score of a party/entity involved in the processing/segregation/recycling/disposal of the marked recyclable materials.

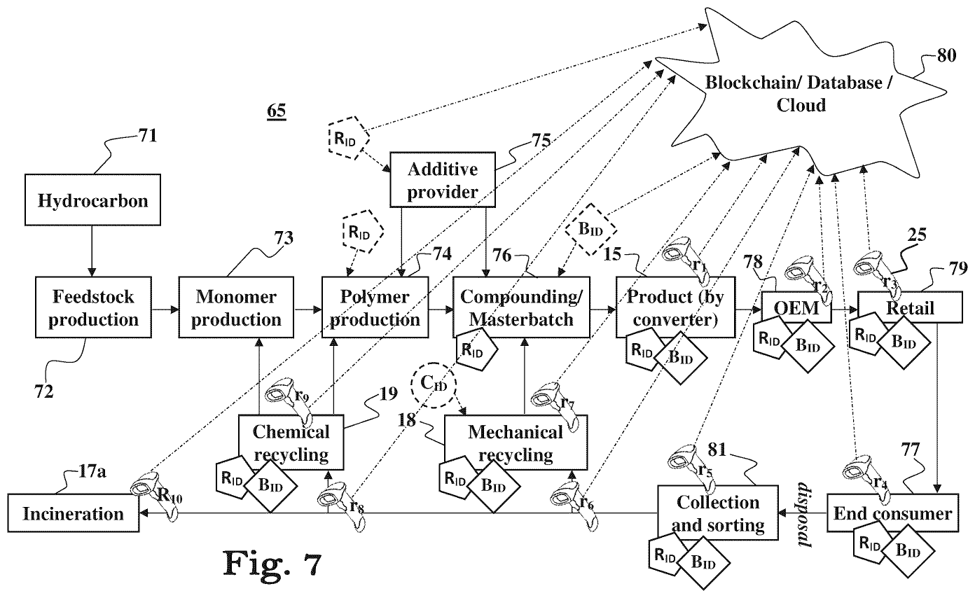

FIG. 7 schematically illustrates system and process (65) for monitoring recyclable materials through their life-cycles, supervised by a monitoring system (80, e.g., remote database, network/cloud, blockchain system), which is usable for determining/recording quality scores/grades and/or currency of recyclable material at each phase of its life-cycle. In this specific and non-limiting example, hydrocarbons (71) is used for feedstock production (72), which is then used for monomer (73) and polymer (74) production. The produced polymer material (74) can undergo a compounding/masterbatch stage (76). Additives (75) can be introduced into the produced recyclable material at the polymer production (74) and/or the compounding/masterbatch (76) stages.

Optionally, chemically recycled material (19), carrying specific manufacturer marking composition (R_{ID}) and/or brand identifying marking composition (B_{ID}), may be added to the recyclable material in the monomer (73) and/or the polymer (74) production stages. Readers (r9) can be used to update the monitoring system (80) about the addition of the chemically recycled material (19) to the produced recyclable material, for which a respective currency and/or quality score/grade indication can be computed and recorded therein, for the respective manufacturer and/or brand parties, using the above defined mathematic operators and functions.

Manufacturer indicative marking compositions (R_{ID}) of the produced recyclable material can be introduced in the polymer production (74) stage, and/or in the additive(s) of the additive provider (75), which can be recorded for the respective manufacturer e.g., as currency and/or quality score/grade indication, in the monitoring system (80). Optionally, mechanically recycled material (18), carrying specific manufacturer marking composition (R_{ID}) and/or brand identifying marking composition (B_{ID}), may be added to the recyclable material in the compounding/masterbatch (76) stage. Readers (r7) can be used to update the monitoring system (80) about the addition of the mechanically recycled material (18) to the produced recyclable material, for which a respective currency and/or quality grade/score indication can be computed and recorded by the monitoring system (80), for the respective manufacturer and/or brand parties, using the above defined mathematic operators and functions.

The produced recyclable material can be then purchased by consumers for manufacture of end products (15), and the ingredient component materials of each such end product can be detected by readers (n), and a respective currency and/or quality score/grade indication can be computed and recorded by the monitoring system (80), for the respective consumer, using the above defined mathematic operators and functions. The end products can be then distributed to the markets (78, 79), and readers (r2, r3) can be used to identify the recyclable materials (i.e., their marking compositions) in the end products, and a respective currency and/or quality score/grade indication can be computed and recorded by the monitoring system (80), for the respective consumers, as disclosed herein. As the end products are sold to end consumers (77), readers (r4) can be used to identify the recyclable materials (i.e., their marking compositions) in the sold end products, and a respective currency and/or quality score/grade indication can be computed and recorded by the monitoring system (80), for the respective end consumers (77).

After use of the end products is terminated, and they are disposed, they can be collected in the waste collection and sorting stage (81). Readers (r5) can be used to in the collection and sorting stage (81) to detected waste products carrying the various marking compositions (R_{ID} and B_{ID}) i.e., contained in the recyclable materials, and respective currency and/or quality score/grade indications can be computed and recorded by the monitoring system (80), for the respective collectors/recyclers, as disclosed herein. The sorted waste materials can be transferred either for mechanical recycling (18), chemical recycling (19) or incineration (17a), and respective readers (r₆, r₈, r₁₀) can be used to detected the various marking compositions (R_{ID} and/or B_{ID}), and respective currency and/or quality score/grade indication can be computed and recorded by the monitoring system (80), for the respective end recyclers/disposers (18, 19, 17a).

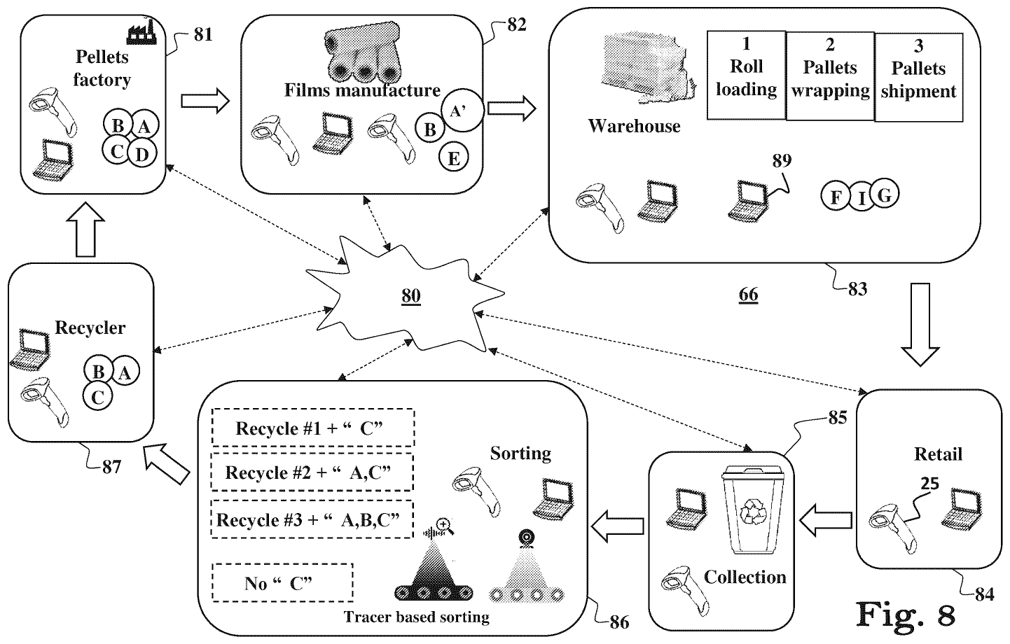

FIG. 8 schematically illustrates a specific non-limiting example for a system and process (66) for monitoring recyclable ingredient component materials of plastic films through their life-cycles. As shown, in a pellets manufacturing stage (81) respective readers can be used to detect marking compositions in the ingredient components materials used to manufacture the pallets e.g., for authenticating via the monitoring system 80 their respective producer and/or for determining the number of recycling processes involved in their preparation, and/or their quality.

Pellets produced in the manufacturing stage (81) can be marked by various different marking compositions “A” (or “B”), “C”, “D”, . . . , or any combination thereof, and the marking compositions used can be detected by a respective reader, and/or respective currencies/quality score/grade indicators computed therefor, can be recorded in the monitoring system (80). For example, marker composition “A” may be used to designate a first recycling round of ingredient component material, marker composition “B” may be used to designate a second recycling round of ingredient component material, and marker composition “C” may be used to designate a producer/manufacturer, of the produced pallets. Optionally, a marker composition “D” is used to designate a batch number of the produced pallets.

In a film manufacture stage (82) readers may be used to detect the marking compositions in the pallets, for example, to authenticate the producer and/or the ingredient component material of the pallets and their quality, via the monitoring system 80. The pallets can be split for different processing required for the film production, and the new concentrations of marking compositions are computed for each processing phase, and recorded in the monitoring system 80. Further readers can be used to detect the marking compositions in the manufactured films e.g., for quality control. Additional marking compositions can be introduced during the manufacture of the films, and recorded in the monitoring system (80), and/or their respective computed currency/quality indicators e.g., indicative of the film manufacturer (A′) and/or of a production serial number (E).

The produced films can be used for wrapping goods in warehouses (83), wherein readers can be used to detect the marking compositions in the wrapping films e.g., to authenticate the manufacturer and/or identify the ingredient component materials and/or their quality scores/grades via the monitoring system (80), and/or to record in the monitoring system (80) respective computed currency/quality score/grade indicators associated with the specific warehouse. The concentrations of the marking compositions in each wrap/roll may be computed, and updated in the monitoring system (80), and additional marking compositions can be applied to each wrap/roll to indicate warehouse identity (I), a serial number of the wrapping machine (F), and/or number of pallets in the roll (G). The wrapped goods are then shipped to marketplaces (84).

A retail (84) can use readers to detected the marking compositions in the nylon wrapping of the retailed goods e.g., to authenticate via monitoring system (80) the manufacturers and/or warehouse, and the ingredient material compositions and/or quality scores/grades of the wrapping films used, and/or to record in the monitoring system (80) respective computed currency/quality scores/grades indicators associated with the specific retailer. Readers can be also used in the collection (85) of disposed nylon wrapping to identify their ingredient component materials and/or quality scores/grades, producer, warehouse etc., update the monitoring system, and/or record in the monitoring system (80) respective computed currency/quality grades/scores indicators associated with a respective waste collector.

In the sorting stage (86) readers can be used to detect in the marker compositions in the waste films, and accordingly sort the waste nylon material, as exemplified in the figure. The monitoring system (80) can be updated with about the sorting of the waste films, and respective computed currency/quality score/grade indicators associated with a respective sorter can be recorded therein. As the sorted waste nylons are recycled (87), respective readers can be used to detect their marking compositions and identify the ingredient component materials, their percentages and/or quality scores/grades, number of recycle processes, etc. New marker marking compositions can be introduced during the recycle process to indicated the percentage of the ingredient component materials and/or the updated number of recycle process, which can be updated in the monitoring system (80), which can further record respective computed currency/quality score/grade indicators associated with the respective recycler.

As shown in FIG. 8, processing means (89 e.g., computer device) can be used in each one of the parties/entities participating in the monitoring system/process (66). i.e. the manufacturer of the recyclable material (81), the manufacturer of products (82) made from the recyclable material, the warehouse (83), the retailer (84), the waste products collector (85), the sorter of waste products (86), and/or the recycler (87). The processing means (89) can be configured and operable to process signals from readers (25), determine presence or absence of the marker/taggant materials is based on the processed signals, accordingly interrogate the database (80) and retrieve information recorded therein indicative of properties of the recyclable materials and/or their ingredient components. The processing means (89) can be configured and operable to determine a quality and/or currency measure for the recyclable materials and/or their ingredient components based on their properties, as obtained from the database (80). The processing means (89) can be configured and operable to communicate with the database (80) over conventional data communication infrastructures (e.g., landlines telephony and/or cable and/or optical fibers), and/or wirelessly (e.g., using cellular telephony and/or other radio frequency data communication).

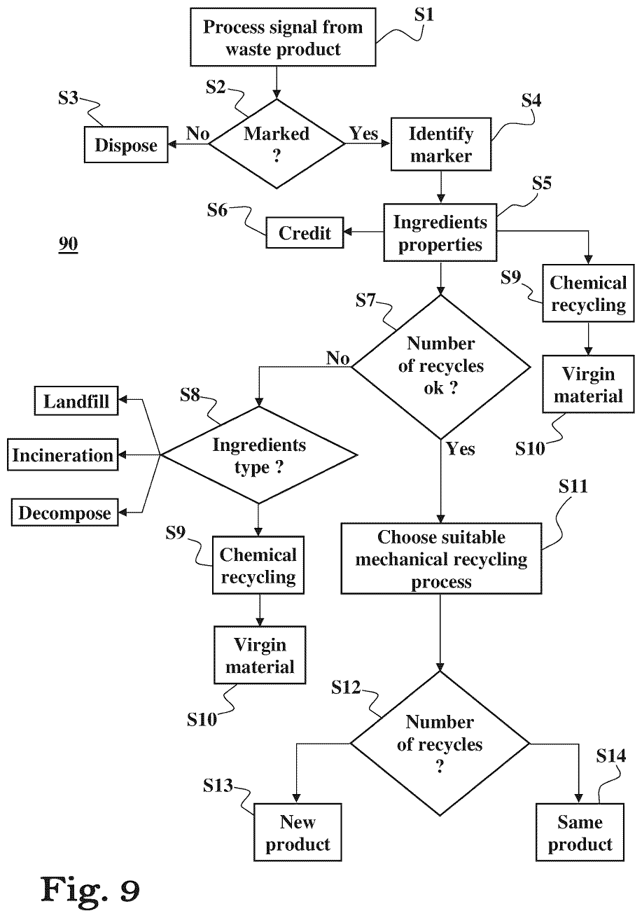

FIG. 9 shows a flowchart 90 demonstrating lifecycles of recyclable materials according to some possible embodiments. As shown in step S1, signals measured by the readers (25) from waste products are processed to detect presence or absence of one or more marker/taggant materials therein. If it is determined in step S2 that the inspected waste products don't include marker/taggant materials, then in step S3 it is transferred for disposal (e.g., landfill, incineration). If one or more marker/taggant materials are detected, in step S4 the measured signals are processed to identify the marker/taggant materials embedded therein.

In step S5 the identified marker/taggant materials are used to determine properties of one or more ingredient material components of recyclable materials contained in the inspected waste product (e.g., material type, content percentage, number of recycle processes, weight, manufacturer, recycler, percentage of virgin material, etc.). Optionally, but in some embodiments preferably, one or more parties/entities (e.g., recycler, waste product collector and/or segregator, manufacturer of the recyclable material and/or of the waste products containing them) identified via the detected marker/taggant materials are credited in step S6 for their contribution to the reduction in environment damage.

The ingredient material components of the recyclable material, as identified in step S5, can be conveyed for chemical recycling S9 if required at this stage. It is noted that chemical recycling (S9) does not necessarily depends on the number of recycle processes the material undergone and can be done at any stage if so decided. The chemical recycling S9 typically results in production of new virgin feedstock material S10, which resets the counting process achieved by introduction of marker/taggant materials for indicating the number of recycle process the material undergone.

If the ingredient material components of the recyclable material, as identified in step S5, didn't undergo chemical recycling, step S7 is used to determine the number of recycle processes of at least one of the one or more ingredient material components of the recyclable material based on the marker/taggant materials identified in step S4, and based on the determined number of recycle processes, whether the recyclable material is in condition to undergo additional recycle processes. If it is determined that the number of recycle processes is greater than a predetermined maximal permitted number of recycling processes for a certain ingredient material component of the recyclable material, then in step S8 a suitable method of disposal is determined based on the types of ingredient material components contained in the waste product e.g., landfill, incineration or decomposition, based on the ingredient material components identified in step S5.

Optionally, but in some embodiments preferably, the waste product can be conveyed for chemical recycling S9 determined according to the types of ingredient material components determined in step S8, based on the marker/taggant materials identified in step S4, which typically results in production of new virgin feedstock material S10.

If it is determined in step S7 that the number of recycle processes is smaller or equal to the predetermined maximal permitted number of recycling processes for the certain ingredient material component of the recyclable material, then in step S11 a suitable mechanical recycling process is determined based on the ingredient material component of recyclable materials identified in step S5.

The recycled materials produced by the mechanical recycling (S11, or by the chemical recycling S9), can be further inspected to determine the type of products they can be used to produce. For example, the inspection in step S12 can determine based on the number of recycle process of at least one of the ingredient material components of the recyclable materials, and/or on the type of ingredient material components, whether to use the recycled material to manufacture a new type of product, or the same type of product i.e., of the waste product.

It should be understood that throughout this disclosure, where a process or method is shown or described, the steps of the method may be performed in any order, or simultaneously, unless it is clear from the context that one step depends on another being performed first.

As described hereinabove and shown in the figures, the present application provides techniques for tagging/marking ingredient component materials, for segregating and recycling the tagged/marked ingredient component materials, and/or for tokenizing/quality monitoring the tagged/marked ingredient component materials, and related methods. While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above, all without exceeding the scope of the claims.

1-41. (canceled)

42. A method of managing production and reuse of a recyclable material, the method comprising:
introducing a combination of markers into one or more ingredient material components of said recyclable material, said combination of markers being indicative of one or more properties of at least one of said ingredient material components comprising at least a type of material used and percentage thereof in said recyclable material; processing a signal obtained from a product comprising said recyclable material and detecting presence of said combination of markers therein;
determining based on the detection of said combination of markers information indicative of said one or more properties, and based on said information deciding either about a suitable recycling process for reusing said at least one ingredient material component or a suitable disposal process for disposing said product.

43. The method of claim 42, wherein the processing of the signal obtained from the product comprises determining concentration of at least one of the markers and/or a ratio thereof, and based thereon determining concentration and/or ratio of at least one of the ingredient material components in the recyclable material, and/or concentration and/or ratio of the at least one ingredient material component to be used for producing of a new recyclable material or a new product therefrom.

44. The method of claim 42, comprising introducing the combination of markers into the one or more ingredient material components of the recyclable material during at least one of the following: processing of row materials of at least one of the ingredient material components; production of raisings or pellets comprising the recyclable material; extrusion, pultrusion, molding and/or forming process applied to said recyclable material; production of the product comprising said recyclable material; use of the product comprising said recyclable material; and/or recycling of the product comprising said recyclable material.

45. The method of claim 42, comprising introducing one or more additional markers into new recycled material recycled from the product, said one or more additional markers being indicative of one or more properties of a recycling process used to recycle said product.

46. The method of claim 42, wherein the introducing of the combination of markers comprises:
introducing a first marking composition to at least one of the one or more ingredient material components during production thereof, said first marking composition being indicative of at least one of a type of material comprised in said at least one ingredient material component, a manufacturer of said at least one ingredient material component, and a percentage of said at least one ingredient material component in said recyclable material; and
introducing a respective additional marking composition during, or after, each recycling process involving said at least one ingredient material component, said respective additional marking composition being indicative of at least one of the following: a number of recycle processes said at least one ingredient material component undergone; a recycling process carried out using said at least one ingredient material component; a recycler carrying out said recycling process; a percentage of said at least one ingredient material component in a newly recycled material produced by said recycling process; and/or a percentage of virgin material in the newly recycled material.

47. The method of claim 46, comprising using the information determined based on the detection of the presence of the combination of markers and/or the additional marking compositions to determine at least one the following: at least one production process carried out using said at least one ingredient material component; at least one recycling process carried out using said at least one ingredient material component; the number of recycle processes carried out using said at least one ingredient material component.

48. The method of claim 42, wherein at least one of the markers and/or the marking compositions is a non-durable marker configured to be substantially removed, decomposed, and/or become unreadable, due to production and/or recycling processes involving said at least one ingredient material component.

49. The method of claim 42, wherein at least one of the markers and/or the marking compositions is a durable marker configured to remain within the recyclable material along all production and/or recycling processes performed throughout its entire life-cycle.

50. The method of claim 42, wherein at least one of the markers and/or the marking compositions is a semi-durable marker configured to partially withstand production and/or recycling processes involving said at least one ingredient material component and thereby diminish its concentration therein, and wherein the processing of the signal obtained from the product comprises determining the concentration of said semi-durable marker, and based thereon determining whether said at least one ingredient material component undergone recycling.

51. The method of claim 50, wherein the determining of the concentration of the semi-durable marker comprises determining the number of recycle processes which the at least one ingredient material component undergone.

52. The method of claim 42, comprising recording in a database record associated with at least one of the markers information indicative of the one or more properties of the of at least one ingredient material component, and/or a recycling process thereof.

53. The method of claim 52, comprising:
collecting waste products and processing a signal obtained from each one of said waste products for determining presence or absence of at least one of the markers or the additional marking compositions;
segregating each of said waste products based on the processed signal obtained therefrom; and
deciding based on the processed signal and information from the associated database record about either a suitable recycling process for reusing said at least one ingredient material component, or a suitable disposal process for disposing said product.

54. The method of claim 42, comprising crediting based on the determined information at least one of the following: a manufacturer of at least one of the ingredient material components, a manufacturer of products comprising the recyclable material, a recycler of said products, a consumer of said recyclable material or said products, an aggregator of waste products comprising said recyclable material or said products, and/or an incinerator of waste products comprising said products.

55. A system for managing production and reuse of a recyclable material, the system comprising:
at least one reader configured to measure a signal from an inspected object, said measured signal being indicative of presence or absence of a combination of markers in said inspected object; and
at least one processing unit configured and operable to process the measured signal from said at least one reader, detect presence of said combination of markers information in said inspected object and determine based thereon information indicative of one or more properties of at least one ingredient material component of a recyclable material comprised in said inspected product, and decide based of the determined information either about a suitable recycling process for reusing said at least one ingredient material component or a suitable disposal process for disposing said product.

56. The system of claim 55, wherein the at least one processing unit is configured and operable to determine based on the determined information at least one of the following: weight of said ingredient material component; a number of recycling processes said at least one ingredient material component undergone; a manufacturer of said at least one ingredient material component, and/or a manufacturer of a product comprising said at least one ingredient material component.

57. The system of claim 55, wherein the at least one processing unit is configured and operable to determine based on the determined information concentration of at least one of the markers and/or a ratio thereof, and based thereon determining concentration and/or ratio of at least one of the ingredient material components of the recyclable material, and/or concentration and/or ratio of the at least one ingredient material component to be used for producing of a new recyclable material or a new product therefrom.

58. The system of claim 55, comprising a database, and wherein the at least one processing unit is configured and operable to store in a record associated in said database with at least one of the markers information indicative of the one or more properties of the of at least one ingredient material component, and/or a recycling process thereof.

59. The system of claim 58, comprising a segregation system, and wherein the at least one processing unit is configured and operable to process signals obtained from waste products processed by said segregation system and determine based thereon presence or absence of at least one of the markers or the additional marking compositions for operating said segregation system based on the processed signal and information from the associated database record to direct each of said waste products either to a suitable recycling process for reusing said at least one ingredient material component, or to a suitable disposal process for disposing said product.

60. A recyclable material comprising one or more ingredient material components and a combination of marking compositions indicative of one or more properties of at least one of said one or more ingredient material components, said combination of marking compositions configured for detection by a reader device for determining a information indicative of at least one of the following: weight of said at least one ingredient material component; a type material of said at least one ingredient material component; number of recycling processes of said at least one ingredient material component; a manufacturer of said at least one ingredient material component; a percentage of said at least one ingredient material component in said recyclable material; a recycling process carried out using said at least one ingredient material component; a recycler carrying out said recycling process; a percentage of said at least one ingredient material component in a newly recycled material produced by said recycling process; and/or a percentage of virgin material in the newly recycled material.

61. The recyclable material of claim 60, wherein the combination marking compositions comprises at least one of a durable, semi-durable, and/or non-durable marker/taggant materials.
